(19) United States
(12) Patent Application Publication
(10) Pub. No.: US 2012/0306817 A1
(43) Pub. Date: Dec. 6, 2012

(54) FLOATING VIRTUAL IMAGE TOUCH SENSING APPARATUS

(75) Inventor: CHIH-HSIUNG LIN, New Taipei City (TW)

(73) Assignee: Era Optoelectronics Inc., New Taipei City (TW)

(21) Appl. No.: 13/244,444

(22) Filed: Sep. 24, 2011

(30) Foreign Application Priority Data
May 30, 2011 (TW) 100118683

(51) Int. Cl. G06F 3/042

(52) U.S. Cl. 345/175

(57) ABSTRACT

A floating virtual image touch sensing apparatus includes at least one optical module generating a floating virtual image, at least one first light source, at least one photosensitive unit, a printing circuit board and a processor; the optical module is coupled to the printing circuit board; the first light source and the photosensitive unit are respectively disposed on the two sides of the optical module. when the optical module generates a floating virtual image, and a light beam emitted from the first light source passes through the virtual image, a body reflects the light beam projected on the virtual image to the photosensitive unit if the body touches the virtual image, the photosensitive unit then output a photosensitive signal, and the processor detects the photosensitive signal, then knows the virtual image is touched, and emits a corresponding control signal.

### BACKGROUND OF THE INVENTION

1. Field of the Invention

The present invention relates to a touch sensing apparatus, and more particularly to a floating virtual image touch sensing apparatus used as a keyboard.

2. Description of Related Art

Taiwan publishing patent NO. 200951771 discloses an apparatus with a virtue touch screen, comprising a screen, an optical mechanism, and a detection module, where the optical mechanism has at least one optical lens. The picture on the screen is formed into a corresponding virtual screen image in a space through the optical mechanism by means of optical imaging principle. The detection module is used to detect whether a user touches the virtual screen image or not, detect and analyze the position of a contact position with the virtual screen, and transfer the position to a contact position with the screen corresponding thereto and signal commands so that the user can operate the digital contents displayed on the virtue screen with a touch control mode, thereby achieving the effect of operating the screen substantially instead of touching it directly; the detection module includes a camera and a signal transceiver.

The mechanism of the above-mentioned Taiwan publishing patent generating a virtual screen image is very complicated, and the signal analysis of an image captured by the camera must be carried out to obtain the signal of a position on which the virtual screen is touched such that the time for obtaining the position signal is rather consumed.

Taiwan Patent No. M398150 discloses a keyboard, including a complex hologram recording holographic information of the keyboard, a projecting light source configured on one side of the complex hologram and a touch panel configured closely to one side of the complex hologram. Projecting light emitted from the projecting light source is projected out a virtual keyboard image on the complex hologram, and the touch panel is used to detect the information of a touched position on the virtual keyboard image.

Because the virtual keyboard image of the Taiwan patent mentioned above is not floating in the air, a human's finger must touch the complex hologram, and the touch panel can then detect a touched position. Therefore, the touched position of the complex hologram will generate a sanitation issue.

An optical module 1 generating floating virtual images is now available in the market, as FIG. 1 shows, for example, a hologram film capable of generating a floating virtual image 10 to a human's vision, or a lenticular sheet combining bar graphs together, allowing a human's left eye and right eye to see different images, and displaying a floating virtual image 10 to a human's vision.

### SUMMARY OF THE INVENTION

To improve a conventional floating virtual image touch sensing apparatus, the present invention is proposed.

The main object of the present invention is to provide a floating virtual image touch sensing apparatus, including at least one optical module generating a floating virtual image, at least one first light source, at least one photosensitive unit, a printing circuit board and a processor, where the optical module generates a floating virtual image, and light emitted from the first light source passes through the virtual image; the photosensitive unit will output a photosensitive signal when a human's finger touch the virtual image to reflect the light to the photosensitive unit; the processor emits a corresponding signal when the processor detects the photosensitive signal output from the photosensitive unit, and knows which virtual image is touched according to which photosensitive unit outputs the photosensitive signal. Therefore, the touch sensing function can be achieved without needing to touch a real screen, and a sanitation issue will not happen.

Another object of the present invention is to provide a floating virtual image touch sensing apparatus, utilizing an optical module generating a floating virtual image to generate a floating virtual image, and a plurality of first light sources and a plurality of photosensitive units to sense which virtual image is touched and emit a corresponding control signal; the structure thereof is simple, thereby reducing a production cost, and which virtual image is touched can then be known quickly without an image signal analysis.

### BRIEF DESCRIPTION OF THE DRAWINGS

The present invention can be more fully understood by reference to the following description and accompanying drawings, in which:

FIG. 1 is a schematic view, showing that a floating virtual image is generated through a conventional optical module; and

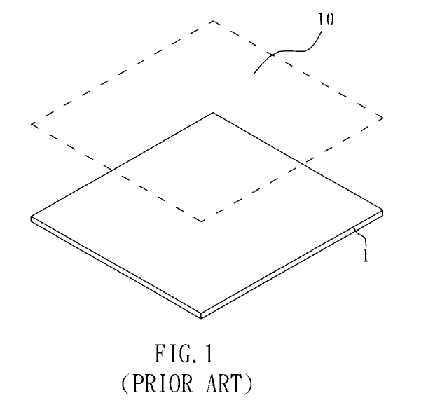

FIG. 2 is a schematic view of a floating virtual image touch sensing apparatus according to the present invention.

### DETAILED DESCRIPTION OF THE PREFERRED EMBODIMENTS

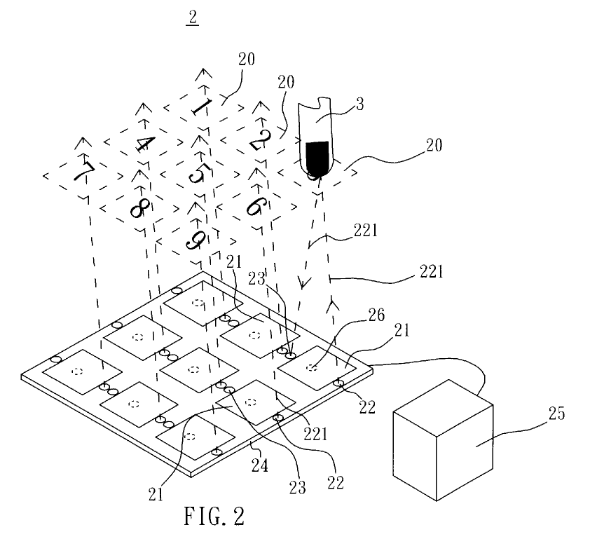

Referring to FIG. 2, a floating virtual image touch sensing apparatus 2 of the present invention includes at least one optical module 21 generating a floating virtual image, at least one first light, source 22, at least one photosensitive unit 23, a printing circuit board 24, a processor 25 and at least one second light source 26.

The optical module 21 is coupled to the printing circuit board 24, the first light source 22 and the photosensitive unit 23 are respectively disposed on the two opposite sides of the optical module 21. The first light source 22, the photosensitive unit 23, the processor 25 and the second light source 26 are respectively electrically connected to the printing circuit board 24.

When the optical module 21 generates a floating virtual image 20, for example, nine optical modules 21 respectively generate digits “1” to “9”, and a light beam 221 emitted from the first light, source 22 passes through the virtual image 20, the light beam 221 projected on the virtual image 20 will be reflected to the photosensitive unit 23 corresponding thereto if a body 3, such as a human's finger, touches this virtual image 20, and the photosensitive unit 23 will then output a photosensitive signal and the other photosensitive unit 23 do not output any photosensitive signal. The processor 25 will know which virtual image 20 is touched and emits a corresponding control signal in accordance with the position of the photosensitive unit 23 on the side of the optical module 21 generating this virtual image 20.

For example, when the body 3 touches the virtual image 20 of digit “3” to reflect the light beam 221 projected on the virtual image 20 of digit “3” to the photosensitive unit 23 on one side of the optical module 23 that generates the virtual image 20 of digit “3”, the photosensitive, unit 23 then outputs a photosensitive signal, and other photosensitive units 23 do not output any photosensitive signal. The processor 25 knows the finger 3 touches the virtual image 20 of digit “3”, and emits a control signal corresponding to the virtual image 20 of digit “3” in accordance with the position of the photosensitive unit 23 on the side of the optical module 21 generating this virtual image 20 when it detects the photosensitive signal output from the photosensitive unit 23.

The optical module 21 of the present invention may be a hologram capable of generating a floating virtual image, and a floating virtual image can be generated to a human's vision. The optical module 21 of the present invention may also a lenticular sheet that combines bar graphs together, allowing a human's left eye and right eye to see different images respectively, and a floating virtual image can be displayed to a human's vision.

The optical module 21 of the present invention may be a hologram illuminated with light from the front or a hologram illuminated with light from the rear; if it is the hologram illuminated with light from the front, the light in front of the hologram is used to illuminate the hologram; if it is the hologram illuminated with light from the rear, light emitted from the second light source behind the hologram may be used to illuminate the hologram. A floating virtual image is displayed in front of the hologram no matter what it is.

The first light source 22 of the present invention may be an invisible light source, for example, infrared light-emitting diode (LED) or laser light source; the light sensing unit 23 may be a photodiode or a photosensitive element; the second light source 26 may be a visible light source, for example, visible light-emitting diode ((LED) or laser light source.

The floating virtual image touch sensing apparatus of the present invention, further improves a conventional floating virtual image control sensing apparatus; it utilizing an optical module generating a floating virtual image to generate a floating virtual image, and a plurality of first light sources and a plurality of photosensitive units to sense which virtual image is touched, thereby emitting a corresponding control signal, which virtual image is touched can then be known quickly without an image signal analysis, and the touch sensing function can be achieved without needing to touch a real screen. Thereupon, a sanitation problem will not be generated. In addition, the structure of the present invention is extremely simple such that the production cost can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A floating virtual image touch sensing apparatus, comprising:
at least one optical module, generating a floating virtual image;
at least one first light source;
at least one photosensitive unit;
a printing circuit board; and
a processor;
wherein said optical module is coupled to said printing circuit board; said first light, source and said photosensitive unit are respectively disposed on sides of said optical module; said first light source, said photosensitive unit and said processor are respectively electrically connected to said printing circuit board; when said optical module generates a floating virtual image, and a light beam emitted from said first light source passes through said virtual image, a body reflects said light beam projected on said virtual image to said photosensitive unit if said body touches said virtual image, said photosensitive unit then output a photosensitive signal, and said processor detects said photosensitive signal, then knows said virtual image is touched, and emits a corresponding control signal.

2. The floating virtual image touch sensing apparatus according to claim 1, wherein said optical module is one selected from a hologram and a lenticular sheet coupling bar graphs together.

3. The floating virtual image touch sensing apparatus according to claim 1, further comprising a second light source; said optical module is a hologram; said second light source being positioned behind said holograph and electrically connected to said printing circuit board; a floating virtual image being displayed in front of said holograph when a light beam emitted from said second light source illuminate said holograph.

4. The floating virtual image touch sensing apparatus according to claim 3, wherein said second light source is a visible light source.

5. The floating virtual image touch sensing apparatus according to claim 4, wherein said visible light, source is one selected from a visible light-emitting diode and laser light source.

6. The floating virtual image touch sensing apparatus according to claim 1, wherein said first light source is an invisible light source.

7. The floating virtual image touch sensing apparatus according to claim 6, wherein said invisible light source is one selected from an infrared light-emitting diode or laser light source.

8. The floating virtual image touch sensing apparatus according to claim 7, wherein said photosensitive unit is one selected from a photodiode or photosensitive element.

9. The floating virtual image touch sensing apparatus according to claim 8, wherein said first light source and said photosensitive unit are respectively positioned on two opposite sides of said optical module.

10. The floating virtual image touch sensing apparatus according to claim 3, wherein said first light source is an invisible light source.

11. The floating virtual image touch sensing apparatus according to claim 10, wherein said invisible light source is one selected from an infrared light-emitting diode or laser light source.

12. The floating virtual image touch sensing apparatus according to claim 11, wherein said photosensitive unit is one selected from a photodiode or photosensitive element.

13. The floating virtual image touch sensing apparatus according to claim 12, wherein said first light source and said photosensitive unit are respectively positioned on two opposite sides of said optical module.

14. The floating virtual image touch sensing apparatus according to claim 4, wherein said first light source is an invisible light source.

15. The floating virtual image touch sensing apparatus according to claim 14, wherein said invisible light source is one selected from an infrared light-emitting diode or laser light source.

16. The floating virtual image touch sensing apparatus according to claim 15, wherein said photosensitive unit is one selected from a photodiode or photosensitive element.

17. The floating virtual image touch sensing apparatus according to claim 16, wherein said first light source and said photosensitive unit are respectively positioned on two opposite sides of said optical module.

18. The floating virtual image touch sensing apparatus according to claim 5, wherein said first light source is an invisible light source.

19. The floating virtual image touch sensing apparatus according to claim 18, wherein said invisible light source is one selected from an infrared light-emitting diode or laser light source.

20. The floating virtual image touch sensing apparatus according to claim 19, wherein said first light source and said photosensitive unit are respectively positioned on two opposite sides of said optical module.
